(19) United States
(12) Patent Application Publication
(10) Pub. No.: US 2004/0215652 A1
(43) Pub. Date: Oct. 28, 2004

(54) Wireless information system and method

(76) Inventors: Joseph Muller, Kirkland, WA (US); Rachel Muller, Kirkland, WA (US)

Correspondence Address: LAW OFFICE OF POLLY L. OLIVER, P.O. BOX 4625, FEDERAL WAY, WA, 98063, US

(21) Appl. No.: 10/810,148

(22) Filed: Mar. 26, 2004

Related U.S. Application Data
(60) Provisional application No. 60/458,363, filed on Mar. 27, 2003.

(51) Int. Cl. G06F 7/00; G06F 17/00; G09G 5/00; H04B 7/00

(52) U.S. Cl. 707/102; 345/864; 370/310

(57) ABSTRACT

A system for providing users of cellular, PCS, and wide-area wireless handsets with quick and short access to local and global information, based on the user's preferences and location. The invention provides a quick link between wireless handset and dedicated information database. Information database is updated constantly by an array of Information Scanners, which run on Internet hosts. The Information Scanners scan Internet web portals, sites, and servers and filter required data into the dedicated info database. The final connection link is between the wireless handset and the Information Scanner array.

### RELATED APPLICATION

This application claims priority under 35 U.S.C. §119(e) to U.S. provisional application Ser. No. 60/458,363, filed on Mar. 27, 2003.

### FIELD OF THE INVENTION

This invention pertains generally to wireless communication systems and more specifically to an information system for wide-area wireless network users.

### BACKGROUND OF THE FIELD

The prior art solution for providing local and other information to wide-area wireless network users is to connect the users' wireless handsets to web sites, messaging and content servers via wireless gateways. Using this prior art system, the user's handset connects through a communication tower to the mobile operator, and thence through the mobile operator's infrastructure to the Internet. The connection is then made across the Internet through wireless gateways to the messaging, location and content servers. Those wireless gateways connect the user across the Internet to the particular web portals and content servers that the user requests. The final link, which is established by these prior art solutions, is between the user's wireless handset and the particular web server host.

This prior art system is quite a complicated multi-step connection that uses up a lot of airtime and battery power.

### SUMMARY OF THE INVENTION

The present invention solves the above-mentioned problems by providing an information system to wireless customers that reduces the amount of both airtime and battery power consumed. These benefits are achieved by a shorter connection time from the user's handset (e.g., cellular, PCS, and wide-area wireless) to the point of information retrieval (e.g., local and global information such as weather forecasts, global news, local traffic and services information, and stock market news). Fewer steps are required of the wireless connection and also fewer and easier steps are required of the user on his or her handset.

In the preferred embodiment of the present invention, the system is area code-driven, by a downloaded applet object that runs in the handset using menu navigation. The user will first select the system icon on his handset screen. That will bring up a main menu (first level menu) comprising several choices of area codes and automatic location identification—for instance, three such area code choices might be “home area code,” “other area code,” and “current location area code.” Inputting an area code, or alternatively using the current location area code of the handset, will bring up a second-level menu of city or other locations identified within that area code from which the user can choose.

Once the user has chosen a city or other location, the handset is connected wirelessly and directly to the proprietary system's array of servers where the information resides, and the information requested is immediately provided in scroll-through format on the user's handset screen. There are also “help” and “last session” options available to the user.

Although the data stream from the user's handset must still be routed through a communications tower to the mobile operator and thence to the Internet, the novelty of the present invention lies in the system operation from that point on. At that point, the data stream is routed directly to the front-end server of the proprietary system (instead of through Wireless Application Protocol or equivalent gateways to Internet websites).

The front-end server is a dedicated database server and is maintained by the proprietary system. It is this server that responds to user requests and provides the requested information to the user's handset. The front-end server is linked to a proprietary back-end server that continuously scans the Internet web portals and other sites and reads information therefrom to be stored in the common database. In this way, the front-end server is constantly fed up-to-date information so that the user does not have to spend his airtime or battery power scanning the Internet for the requested information.

Once information is requested from the front-end server, the handset location of the user is stored in the information database so that Internet hosts can later request and receive the last known location of the user from the common information database.

I. Applet Object.

The applet object of the present invention resides and runs in the user's handset and in the preferred embodiment is downloadable from the user's wireless carrier. The applet object comprises the elements of file interface, user entry interface, network interface, display GUI interface, TAPI interface, menu interface, sector location interface, shell interface, and position location interface. These elements are electronically linked together and are applied within the applet object to process the user input information, including menu choices, and can be configured to operate within a runtime environment such as the Binary Runtime Environment for Wireless (BREW). The architecture of the applet object is described in FIG. 4.

II. Information Scanner Array

The Information Scanner Array comprises front-end and back-end servers and their common database. The Array also comprises the necessary interfaces for service providers, windows sockets, information scanning, and wireless user information provider. The architecture of the Information Scanner Array is described in FIG. 5.

### BRIEF DESCRIPTION OF THE DRAWINGS

FIG. 1 is a block diagram of the prior art;

FIG. 2 is a block diagram of the present invention in the preferred embodiment;

FIG. 3 is a schematic view of the activity sequence of the present invention;

FIG. 4 is schematic view of the applet object architecture; and

FIG. 5 is a schematic view of the scanner array architecture.

### DETAILED DESCRIPTION OF THE PREFERRED EMBODIMENT

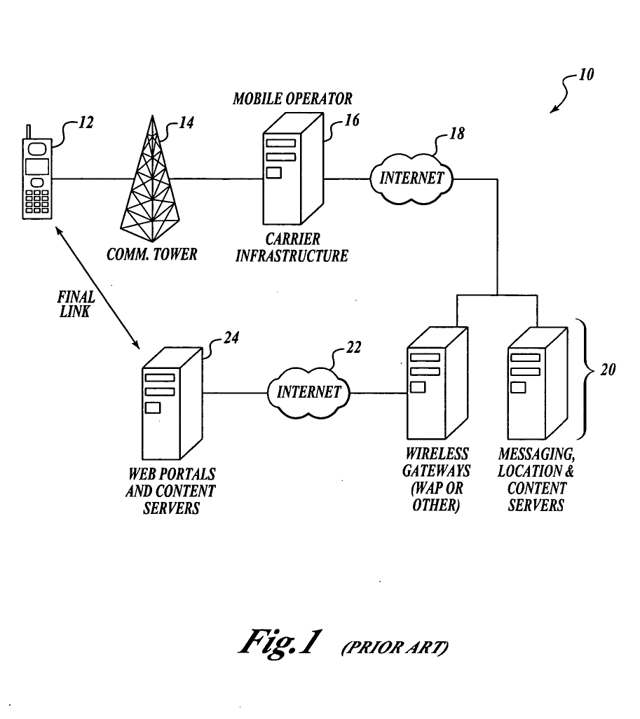

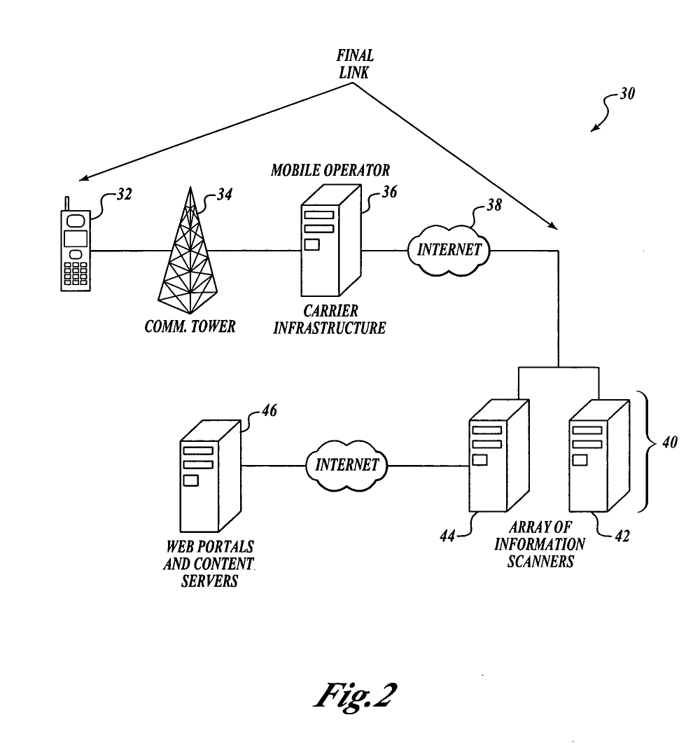

FIG. 1 shows how in the prior art system 10, the final wireless link is between a user's handset 12 and the particular Web portal or server 24 containing the requested information. In FIG. 2, one can see that the final wireless link of the present invention system 30 is between the user's handset 32 and the Information Scanner Array 40. Although the data stream from the user's handset 12, 32 must still be routed through a communications tower 14, 34 to the mobile operator 16, 36 and thence to the Internet 18, 38, the novelty of the present invention system 30 lies in the system operation from that point on.

In the system 30 of the present invention, the wireless gateways and messaging, location, and content servers 20 have been replaced by the Information Scanner Array 40 comprising a Front-end Server 42 and Back-end Server 44 linked to each other so that they can share information and having a common database.

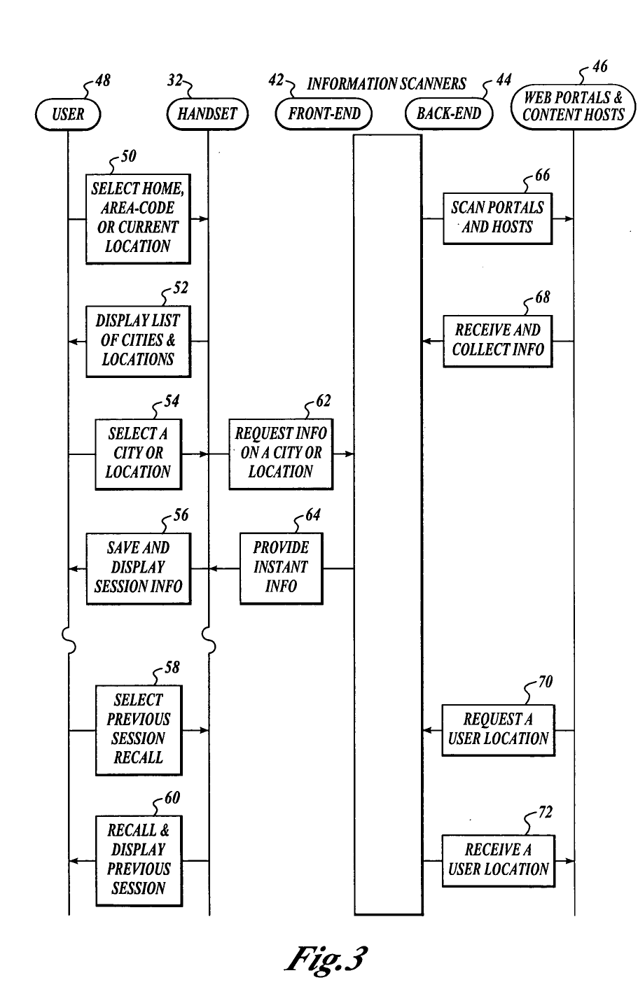

FIG. 3 shows schematically the activity sequence of the preferred embodiment in which the user 48, the handset 32, the front-end server 42, the back-end server 44, and the web portals and content hosts 46 are represented by vertical lines, and the steps of the activity sequence (method of operation) are represented in flowchart mode.

In a typical session using the system of the preferred embodiment, the user 48 makes an information request by navigating through an area-code driven menu on the handset 32 and entering a plurality of menu choices on various menu levels on the handset 32, e.g., the user selects an area code in step 50—either the user's home area code, another preferred area code, or the handset's current area code; the handset 32 then in step 52 displays a list of cities and other locations within that area code to further narrow the user's choice; after the user 48 makes a selection of specific city or location from this next-level menu in step 54, the handset in step 62 establishes a wireless connection to the Information Array and transmits the request to the front-end server 42; in step 64 the front-end server 42 instantly provides the requested information to handset 32 from the common database that it shares with the back-end server 44; in step 56 the handset 32 displays the requested information and also saves same for later retrieval by the user 48. Step 58 shows that the user 48 then has the option at some later time to recall this stored information. Upon making such recall, the handset in step 60 will recall and display the stored information.

Meanwhile and continuously, the back-end server 44, which is linked to the front-end server 42, is scanning Internet (web) portals and content hosts 46 as described in step 66. As it scans, it is receiving and collecting information in step 68 from the said portals and hosts 46 and storing the information on the common database accessible by the front-end server 42. As an added safeguard, the web portals and content hosts 46 can request from the back-end server in step 70 and receive from the back-end server in step 72 a user location.

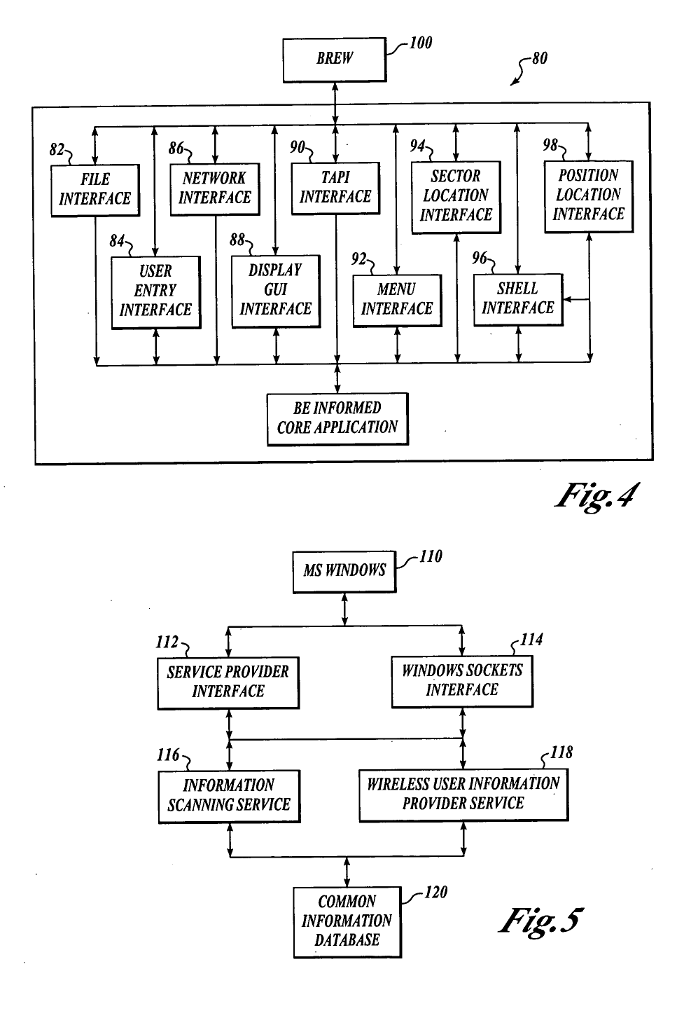

FIG. 4 shows the architecture of the applet object 80 as it runs in the handset 32. The Binary Runtime Environment for Wireless (BREW) environment 100 has been chosen for illustrative purposes, but it is understood that any appropriate run-time environment would satisfy. As shown, the applet object 80 comprises various interfaces allowing the menu operation and interaction with the user 48 as well as cooperation with the core application of the information system 30 of the present invention. These interfaces include file interface 82, user entry interface 84, network interface 86, display GUI interface 88, TAPI interface 90, menu interface 92, sector location interface 94, shell interface 96, and position location interface 98. These interfaces are all linked together according to the diagram in FIG. 4 and operate as above. Once the applet 80 has run, then the handset 32 sends the applet output (information request) to the Scanner Array Front-end Server 42.

FIG. 5 shows the architecture of the scanner array. Both servers are typically configured to operate in the Microsoft Windows™ platform 110. The front-end server 42 comprises a service provider interface 112 linked with the information scanning service 116. The back-end server 44 comprises a windows socket interface 114 linked with the wireless user information provider service 118 of the present invention. Both servers share a common information database 120.

What is claimed is:

1. A wireless information system comprising:
A wireless communication handset with applet object code residing therein and having a user menu which is area code driven;
A scanner array connected wirelessly thereto and comprising a front-end server and a back-end server sharing a common database, such front-end server being wirelessly linked to the handset so as to exchange information therewith, and the back-end server continuously updating the common database by scanning Internet web portals and content hosts.

2. The wireless information system of claim 1 wherein the applet object comprises the linked elements of a file interface, a user entry interface, a network interface, a display GUI interface, a TAPI interface, a menu interface, a sector location interface, a shell interface, and a position location interface, all of which operate in the Binary Runtime Environment for Windows.

3. The wireless information system of claim 1 wherein the front-end server runs on the Microsoft Windows™ platform, comprises a service provider interface, shares a common information database with the back-end server, and provides the information scanning service.

4. The wireless information system of claim 3 wherein the back-end server runs on the Microsoft Windows™ platform, comprises a window sockets interface, shares a common information database with the front-end server, and provides the wireless user information service.

5. The wireless information system of claim 1 wherein the menu comprises the choices of home area code, current location area code, or other preferred area code.

6. The wireless information system of claim 5 wherein the area code menu choice is responded to with a further menu choice of city or other location within said area code.

7. The wireless information system of claim 1 wherein the user menu comprises at least two levels, the first level offering area code choices and the second level offering city and other location choices.

8. The wireless information system of claim 1 wherein the handset is chosen from the group comprising cellular, PCS, and wide-area wireless handsets.

9. A method of providing information to wireless users comprising the steps of:
The user inputting at least one menu choice from a wireless communications handset, the handset running an applet object to process the menu choices and then connecting wirelessly to a front-end server of a scanner array, the front-end server requesting and retrieving the requested information from a common database shared with a back-end server linked thereto and transmitting the information to the handset, and the back-end server continuously updating the information in the common database so that it is accessible to the front-end server.

10. The method of claim 9 wherein the user makes the menu choice based on area code.

11. The method of claim 9 wherein the user makes the menu choice by navigating through a plurality of menu levels.

12. The method of claim 9 wherein the wireless connection is routed through a communications tower, a mobile operator, and the Internet.

13. The method of claim 9 further comprising the step of the user retrieving the saved information from the last session.

14. The method of claim 9 wherein the back-end server of the scanner array continuously updates the common database by scanning web portals and content servers.
